(19) United States
(12) Patent Application Publication
(10) Pub. No.: US 2005/0150143 A1
(43) Pub. Date: Jul. 14, 2005

(54) Loader/excavator-type heavy construction machine and method of controlling the operation of one such machine

(75) Inventor: Georges Charles, Limas (FR)

Correspondence Address: BURR & BROWN, PO BOX 7068, SYRACUSE, NY, 13261-7068, US

(73) Assignee: Volvo Construction Equipment Holding Sweden AB, Eskilstuna (SE)

(21) Appl. No.: 11/054,227

(22) Filed: Feb. 9, 2005

Related U.S. Application Data
(63) Continuation of application No. PCT/FR03/50065, filed on Sep. 24, 2003.

(30) Foreign Application Priority Data
Sep. 26, 2002 (FR) 02.11917

(51) Int. Cl. H01S 3/10

(52) U.S. Cl. 37/414

(57) ABSTRACT

The invention relates to a loader/excavator-type heavy-construction machine comprising a hydraulic system which powers one or more hydraulic actuators. The aforementioned hydraulic system is equipped with a variable-delivery pump which can operate in two different modes, namely full power mode for use as an excavator and reduced power mode for use as a loader. The invention is characterized in that it also comprises a temperature sensor which is used to determine the temperature of the oil in the hydraulic system and means of automatically switching the operation of the pump from full power mode to reduced power mode when the oil temperature exceeds a pre-determined threshold.

### TECHNICAL FIELD

The invention relates to the field of heavy-construction machines. It is concerned more precisely with machines equipped with a hydraulic circuit and performing the combined functions of loader and excavator. It relates more specifically to special hydraulic circuit equipment intended to protect these circuits from the rises in temperature of the oil circulating therein.

### PRIOR ART

Heavy-construction machines are generally equipped with a hydraulic circuit inside which oil circulates. This hydraulic circuit supplies the various cylinders of the operating equipment which move and are deployed during the various maneuvers of the machine. During operation, and particularly when the machine has a considerable work load, for example when carrying out excavations at “depth” for a long period of time, the temperature of the oil circulating in the hydraulic circuit rises. An excessive rise in this temperature causes deterioration not only of the oil but of various heat-sensitive elements of the hydraulic circuit. Mention may be made particularly of the various seals equipping the hydraulic distributors, or else the cylinders. In the event of the hydraulic circuit overheating, it is then possible to observe sealing failures, inter alia.

It will therefore be appreciated that monitoring the temperature of the oil in the hydraulic circuit is important to ensure the reliability of a machine. Up until now, this monitoring has been carried out using a temperature probe which is generally installed at the oil reservoir and which is connected to a device triggering a visual and/or audible alarm inside the driver's cab. It will be appreciated that this alarm is not really sufficient since it does nothing more than signal to the driver that the oil temperature has exceeded a predetermined threshold, generally in the vicinity of 97° C. If the driver makes a deliberate decision to continue operating the machine, the oil temperature may continue to increase, with the risks of deterioration mentioned above.

A problem which the invention aims to solve is to provide the hydraulic circuit with effective protection from rises in temperature and to do so irrespective of the driver's behavior.

Moreover, loader/excavators comprise two different pieces of operating equipment operating under separate conditions and performing separate functions. Thus, a loader/excavator comprises an articulated shovel which is used to make trenches or, more generally, to excavate the soil in the vicinity of the point at which the machine is parked. This shovel is generally maneuvered while the machine is stopped. On the other hand, a loader/excavator comprises a loading bucket which is used to take material deposited on the ground so that it can be transported and loaded, for example into a truck trailer situated at a different location. In this case, the internal combustion engine of the machine must provide the power required not only for maneuvering the bucket but also for moving the machine. In other words, when the machine is operating as a loader, the hydraulic circuit cannot consume the entirety of the power supplied by the internal combustion engine, since a portion is required for the traction function. Conversely, when the machine is operating as an excavator and is therefore stationary, the hydraulic circuit can utilize virtually the entirety of the power delivered by the internal combustion engine.

This is why the hydraulic circuit in this type of machine is equipped with a variable-delivery pump which can operate in two separate modes. Thus, in a “full power” mode, the pump is regulated such that it can utilize virtually all the power delivered by the internal combustion engine. Conversely, when it is required to retain a portion of the power delivered by the internal combustion engine for the traction functions, the variable-delivery pump is regulated according to a “reduced power” mode. The possibility of having the maximum pump delivery is thus kept, which makes it possible to retain satisfactory performance in terms of rate. In practice, the shift to a reduced power mode takes place as soon as a gear is engaged. Consequently, a certain power is therefore reserved for the traction functions carried out simultaneously with loading functions.

### SUMMARY OF THE INVENTION

The invention therefore relates to a loader/excavator-type heavy-construction machine comprising a hydraulic circuit supplying one or more hydraulic actuators, for example one or more cylinders situated on one or more pieces of operating equipment.

In a known way, this hydraulic circuit is equipped with a variable-delivery pump which can operate in two separate modes, namely a “full power” mode assigned for excavator operation and a “reduced power” mode assigned for loader operation.

According to the invention, this machine is characterized in that it also comprises a temperature sensor which is used to determine the temperature of the oil circulating in the hydraulic circuit. It also comprises means for automatically switching the operation of the pump from the “full power” mode to the “reduced power” mode when the oil temperature exceeds a predetermined threshold.

In other words, the invention involves limiting the power available for the hydraulic circuit by reducing the maximum power of the variable-delivery pump when the temperature exceeds a predetermined threshold, typically around 90° C. This switching takes place automatically without requiring the intervention of the driver. The shift to reduced power mode means that the losses due to friction within the hydraulic circuit are reduced and therefore normally lead to a drop in the oil temperature. Thus, the driver can continue to carry out the various operations while benefiting, however, from a lower rate of execution, but with the integrity of the hydraulic circuit being preserved.

Thus, the invention uses existing pumps which are designed to operate in two separate modes depending on the work carried out by the machine, that is to say loader work or excavator work. The invention consists in taking advantage of the possibility of changing the mode to provide protection from rises in temperature. In other words, the pump mode changes not only when the driver shifts from loader to excavator operation (and vice versa), but also when the temperature rises abnormally. The pump can therefore be forced to operate in “reduced power” mode even when the machine is being used as an excavator, in the event of the oil temperature being too high. It will be noted that the shift to “reduced power” mode does not alter the operation of the internal combustion engine and does not therefore not reduce the performance of the engine in terms of its movement.

In a preferred form, provision may be made for the machine to also comprise means for switching the operation of the pump back to full power mode again when the oil temperature decreases by a predetermined magnitude. This means that when the oil temperature has lowered sufficiently, the machine can then be allowed to operate at full power.

The lowering of the temperature may be monitored in various ways.

Thus, in a first variant embodiment, the return to full power mode takes place when the temperature of the oil circuit has remained below the aforementioned trigger threshold for a predetermined time. In other words the reduction in the oil temperature is then estimated according to a time which depends on the parameters of the hydraulic circuit, specifically its volume, its geometry, etc., and also the intrinsic characteristics of the oil used, particularly its specific heat capacity. In practice, it is considered that if the temperature has remained below the predetermined threshold for a given time, of around seven minutes, that is sufficient to obtain a lowering of the temperature of around 15° C., with the result that it is then possible to allow operation at full power once more.

In another variant embodiment, the return to the full power mode takes place when the temperature passes below a second predetermined threshold. In other words, the temperature of the oil circuit is then monitored, and switching to the full power mode is allowed when the measurement of this temperature indicates that it has lowered sufficiently.

In practice, the hydraulic circuit can then be equipped with an analog temperature sensor associated with an electronic control unit and able to initiate the switching from the full power mode to the reduced power mode and vice versa, as a function of the comparison of the temperature of the oil circuit with the two predetermined temperature thresholds. However, a similar result can be obtained by using two separate temperature sensors or probes having different trigger thresholds, corresponding, in the case of the higher threshold, to the switching to the reduced power mode, and, in the case of the lower threshold, to the converse switching, i.e. to the full power mode.

In practice, the machine comprises an electronic control unit connected to the temperature sensor and acting on a solenoid valve of the circuit in which the variable-delivery pump is configured. Depending on the control of this solenoid valve, the variable-delivery pump is capable of delivering an output and a pressure corresponding to the power levels of each operating mode.

Advantageously, in practice, the machine may also comprise a specific temperature probe connected to a visual and/or audible alarm present in the cab. Consequently, the driver is informed of an untimely temperature rise that could not be contained by switching to reduced power mode.

### BRIEF DESCRIPTION OF THE FIGURES

The implementation of the invention, together with the advantages arising therefrom, will become clearly apparent from the description of the embodiments which follow, aided by the appended figures in which:

FIG. 1 is a simplified partial diagram of the hydraulic circuit of a machine according to the invention.

FIG. 2 is a diagram showing the variation of the maximum pressure generated by the pump as a function of the output, specifically with respect to two separate power levels.

FIG. 3 is a timing diagram showing the change in the oil temperature over time when this temperature is regulated according to a first variant embodiment.

FIG. 4 is a timing diagram similar to that shown in FIG. 3, but corresponding to a variant embodiment.

### IMPLEMENTATION OF THE INVENTION

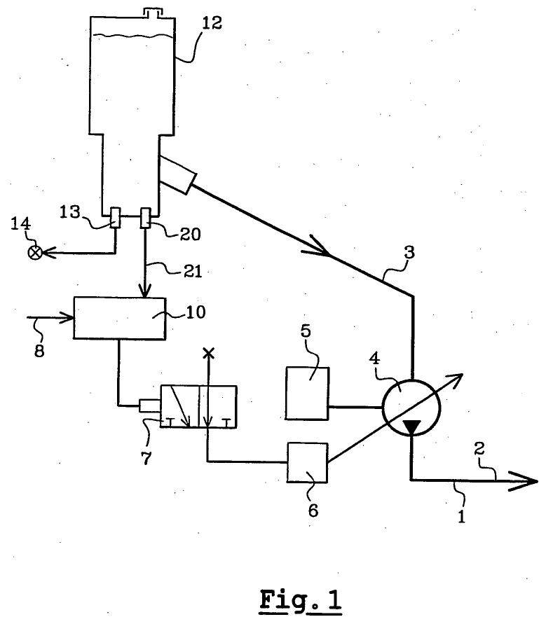

The hydraulic circuit (1) illustrated in FIG. 1 comprises various tubes (2) routed toward or originating from the various hydraulically operated elements, such as cylinders, hydraulic motors or other distributors, which do not have a direct bearing on the invention and will therefore not be described or represented in detail. This hydraulic circuit (1) comprises a variable-delivery pump (4) which is driven by the internal combustion engine (5) of the machine. The pump (4) is connected to the oil reservoir (12) by means of an intake line (3). The flow rate and pressured delivered by the pump (4) are regulated by a system (6) known per se, which will not be described in any more detail. This regulating device (6) particularly allows the pump (4) to operate in two separate modes, namely a full power mode and a reduced power mode, in which about two-thirds of the power is available with respect to the full power mode. The shift from one mode to the other is controlled by means of a solenoid valve (7). This solenoid valve (7) is controlled as a function of an electrical signal (8) indicating the engagement of a gear at the driver's cab.

In the form illustrated, this information on the engagement of a gear is processed by an electronic control unit (10).

The hydraulic circuit comprises a reservoir (12), which is equipped with a temperature probe (13) connected to a visual or audible alarm device (14) installed in the cab so as to warn the driver.

According to the invention, the hydraulic circuit is equipped with a temperature sensor (20) which, in the form illustrated, is installed at the reservoir (12). However, this sensor could be installed at a different location without, however, departing from the scope of the invention. This sensor (20) may be either an analog sensor delivering an analog electrical signal, or else a temperature probe delivering an electrical signal which can adopt two values depending on whether the temperature that the sensor detects is greater or lower than a predetermined adjustment threshold. This information (21) is forwarded to the control unit (10). As a function of this information, the control unit (10) controls the solenoid valve (7) so as to impose an operation of the pump (4) either in full power mode or in reduced power mode.

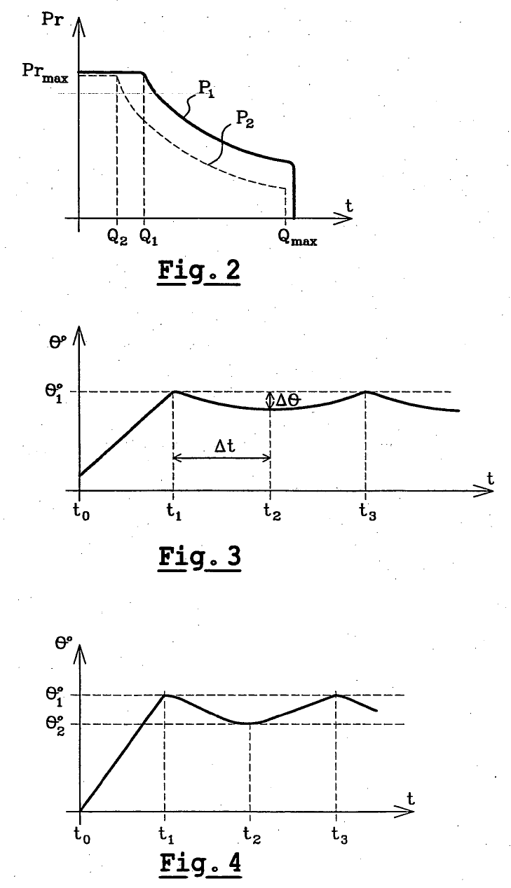

These two operating modes are illustrated in FIG. 2. Thus, the curve P₁ corresponding to the full power operating mode describes the change in the maximum pressure delivered by the pump as a function of the flow rate (Q). This pressure Pr equals a value Prₘₐₓ up to a flow rate Q₁. Beyond this flow rate, this pressure decreases as far as the maximum value of the flow rate Qₘₐₓ following a curve similar to a hyperbola, corresponding to an equal power.

The broken-line curve P₂ corresponds to a configuration in which the maximum power available is less, which means that the maximum power delivered by the pump follows the equal-power hyperbola beyond the flow rate Q₂.

The mode of operation of the invention is as follows.

Thus, as illustrated in FIG. 3, the temperature θ of the oil in the hydraulic circuit rises when the machine is used, starting from time t₀. Since the temperature is below the temperature threshold θ₁, the pump is in the full power operating mode. In practice, the threshold θ₁ is fixed at a value of around 90° C., give or take three degrees. At time t₁, the temperature sensor (20) indicates that the oil temperature exceeds the threshold θ₁, with the result that the central control unit (10) controls the solenoid valve (7) in a suitable manner to shift the pump (4) into the reduced power mode. Consequently, since the power passing through the hydraulic circuit is less, the losses due to friction and the like are also reduced. The oil temperature therefore decreases slightly, starting from t₁.

The time Δt which is necessary to obtain a drop in temperature Δθ is in fact estimated by prior calculations. In practice, a time of seven minutes is generally considered necessary to obtain a lowering of the temperature by 15° C. However, these values are dependent on the characteristics of the hydraulic circuit and on the power ratios employed between the various operating modes, with the result that the invention is not limited to these values alone.

Thus, at time t₂, after a time Δt has elapsed since t₁, the electronic control unit (10) again allows operation in full power mode, with the result that a further increase in the temperature up to time t₃ is then observed. The same regulating principle then applies with the implementation of a delay Δt as described above.

However, the regulation may be achieved according to another operating mode, illustrated in FIG. 4.

In this case, the shift to reduced power mode also takes place at t₁ as soon as the temperature θ exceeds the threshold θ₁. Subsequently, the temperature continues to be detected by the sensor (20), and as soon as the information generated by this sensor (20) indicates that the oil temperature has passed below a threshold θ₂, the control unit (10) then allows a further shift to the full power mode. The temperature then starts to increase again, between times t₂ and t₃, and then the regulating principle described above applies for the subsequent periods. Of course, the information relating to the temperature of the oil circuit may be obtained by a single sensor, as illustrated in FIG. 1, but it may also come from two separate sensors which, then, can generate binary information corresponding to the temperature passing above the two thresholds θ₁ and θ₂.

It emerges from the foregoing that the machine according to the invention has the advantage of providing automatic security against overheating of the oil circuit, since it reduces the power available for the hydraulic circuit when the temperature exceeds a predetermined threshold.

1. A loader/excavator-type heavy-construction machine comprising a hydraulic circuit (1) supplying one or more hydraulic actuators, said hydraulic circuit being equipped with a variable-delivery pump (4) which can operate in two separate modes, namely a “full power” mode assigned for excavator operation and a “reduced power” mode assigned for loader operation, keeping the possibility of having the maximum pump delivery, characterized in that it also comprises a temperature sensor (20) used to determine the temperature of the oil circulating in the hydraulic circuit (1), and means for automatically switching the operation of the pump (4) from the “full power” mode to the “reduced power” mode when the oil temperature exceeds a predetermined threshold.

2. The machine as claimed in claim 1, characterized in that it comprises a means for switching the operation of the pump (4) from the reduced power mode to the full power mode when the oil temperature decreases by a predetermined magnitude.

3. The machine as claimed in claim 2, characterized in that it comprises means for switching the operation of the pump (4) from the reduced power mode to the full power mode when the oil temperature has remained below said predetermined threshold θ₁ for a predetermined time Δt.

4. The machine as claimed in claim 2, characterized in that it comprises means for switching the operation of the pump (4) from the reduced power mode to the full power mode when the oil temperature passes below a second predetermined threshold θ₂.

5. The machine as claimed in claim 4, characterized in that it comprises an analog temperature sensor (20) associated with an electronic control unit (10) and able to initiate the switching from the full power mode to the reduced power mode and vice versa, as a function of the comparison of the oil temperature with the two predetermined temperature thresholds.

6. The machine as claimed in claim 4, characterized in that it comprises two temperature sensors having different trigger thresholds.

7. The machine as claimed in claim 1, characterized in that it comprises an electronic control unit (10) connected to the temperature sensors and acting on a solenoid valve (7) of the circuit in which the variable-delivery pump (4) is configured.

8. The machine as claimed in claim 1, characterized in that it also comprises a temperature probe (13) connected to a visual and/or audible alarm (14) present in the cab.

9. A method of controlling the operation of a loader/excavator-type heavy-construction machine equipped with a hydraulic circuit, said hydraulic circuit being equipped with a variable-delivery pump (4) which can operate in two separate modes, namely a “full power” mode assigned for excavator operation and a “reduced power” mode assigned for loader operation, characterized in that it makes it possible to determine the temperature of the oil circulating in the hydraulic circuit (1) and to automatically switch the operation of the pump (4) from the “full power” mode to the “reduced power” mode when the oil temperature exceeds a predetermined threshold.

10. The method as claimed in claim 9, characterized in that it makes it possible to switch the operation of the pump (4) from the reduced power mode to the full power mode when the oil temperature decreases by a predetermined magnitude.
